(19) United States
(12) Patent Application Publication
(10) Pub. No.: US 2016/0345615 A1
(43) Pub. Date: Dec. 1, 2016

(54) STARCH-BASED EGG WHITE EXTENDER IN BAKED FOODSTUFFS

(71) Applicant: CORN PRODUCTS DEVELOPMENT, INC., SAO PAULO (BR)

(72) Inventors: Matthew Yurgec, Bridgewater, NJ (US); Dilek Uzunalioglu, Millington, NJ (US)

(73) Assignee: CORN PRODUCTS DEVELOPMENT, INC., SAO PAULO (BR)

(21) Appl. No.: 14/308,024

(22) Filed: Jun. 18, 2014

(51) Int. Cl. A23L 15/00; A21D 13/08; A21D 2/18; A23L 29/269; A23L 29/212

(52) U.S. Cl. CPC A23L 15/35; A23L 29/27; A23L 29/212; A21D 2/186; A21D 13/08; A23V 2002/00

(57) ABSTRACT

A composition useful as an extender for egg whites in a baked foodstuff comprising a major amount of a non-waxy wheat starch and a minor amount of granular xanthan gum, said granular xanthan gum having a mean particle size greater than 40 micrometers is provided. Also provided is a method of replacing egg whites in a baked foodstuff comprising adding a major amount of a non-waxy wheat starch and a minor amount of granular xanthan gum, said granular xanthan gum having a mean particle size greater than 40 micrometers, to replace a portion of the egg whites in a baked foodstuff. A baked foodstuff comprised of egg whites, wherein at a portion of the egg whites are replaced with a major amount of a non-waxy wheat starch and a minor amount of granular xanthan gum, said granular xanthan gum having a mean particle size greater than 40 micrometers is also provided. It has been found that if xanthan gum of a relatively coarse grind is used as a partial replacement for egg whites to prepare a baked foodstuff, such as an angel food cake, then improved properties of the baked foodstuffs are obtained as compared to the use of xanthan gum of a relatively fine grind.

### BACKGROUND OF THE INVENTION

Egg albumen, or egg whites, are a known food ingredient in a number of foodstuffs, particularly baked foodstuffs, for example angel food cakes. Due to the expense of egg whites, extenders or replacements for egg whites have been developed.

U.S. Pat. No. 4,238,519 (Chang) discloses an egg albumen extender comprised of a protein-containing composition having certain characteristics and other ingredients, including gums such as xanthan, but preferably carrageenan. Xanthan gum, along with water and wheat starch is suggested as a partial replacement for egg whites in angel food cakes by L. L. Miller, et al, “Xanthan Gum in a Reduced Egg White Angel Food Cake”, Cereal Chemistry, 60(1): 62-64 (1983).

### SUMMARY OF THE INVENTION

In one aspect, this invention relates to a composition useful as an extender for egg whites in a baked foodstuff comprising a major amount of a non-waxy wheat starch and a minor amount of granular xanthan gum, said granular xanthan gum having a mean particle size greater than 40 micrometers. In a related embodiment, the composition is further comprised of a minor amount of a dextrin, preferably a white dextrin.

In another aspect, this invention relates to a method of replacing egg whites in a baked foodstuff comprising adding water, a major amount of a non-waxy wheat starch and a minor amount of granular xanthan gum, said granular xanthan gum having a mean particle size greater than 40 micrometers (and preferably a minor amount of a dextrin), to replace a portion of the egg whites in a baked foodstuff.

In another aspect, this invention relates to a baked foodstuff comprised of egg whites, wherein at least a portion of the egg whites are replaced with a major amount of a non-waxy wheat starch and a minor amount of granular xanthan gum, said granular xanthan gum having a mean particle size greater than 40 micrometers (and preferably a minor amount of a dextrin).

It has been found that if xanthan gum of a relatively coarse grind is used as a partial replacement for egg whites to prepare a baked foodstuff, such as an angel food cake, then improved properties of the baked foodstuffs are obtained as compared to the use of xanthan gum of a relatively fine grind.

### DETAILED DESCRIPTION

Wheat is a cereal plant of the genus Triticum of the family Gramineae (grass family). Modern wheat varieties are usually classified as winter wheat (fall-planted) and spring wheat. Wheat starch is typically separated from processed wheat grains or milled flours by hydroprocessing. In general, wheat starch is isolated from wheat gluten and fibers by washing of the starch granules from the gluten and fibers, Such washing typically produces an “A” fraction of larger granules (typically averaging from about 20 to about 35 micrometers in size) and “B” fraction of smaller granules (typically averaging from about 2 to about 15 micrometers in size). The term “wheat starch” as used herein includes both fractions individually and mixtures thereof, The term “non-waxy wheat starch” as used herein means wheat starch derived from cultivars in which the starch is comprised of both amylose and amylopectin molecules, Non-waxy wheat starch is distinguished from wheat starch from waxy wheat cultivars wherein the wheat starch is essentially free of amylose molecules. The starch may be minimally modified prior to use, e.g. physically, thermally or chemically, if desired, but is preferably used in its native state.

Xanthan gum is an extracellular polysaccharide secreted by the micro-organism Xanthomonas campestris. Xanthan gum is soluble in cold water and solutions exhibit highly pseudoplastic flow. The bacterium Xanthomonas campestris produces the polysaccharide at the cell wall surface during its normal life cycle by a complex enzymatic process. Commercially, xanthan gum is typically produced from a pure culture of the bacterium by an aerobic, submerged fermentation process. The bacteria are typically cultured in a well-aerated medium containing glucose, a nitrogen source and various trace elements. To provide seed for the final fermentation stage, the process of inoculum build-up is carried out in several stages. When the final fermentation has finished the broth is pasteurized to kill the bacteria and the xanthan gum is recovered by precipitation with isopropyl alcohol. Finally, the isolated product is dried to a crude form and the crude form is then mined to form granules. The particle size of the crude xanthan gum can be reduced using milling machines such as the bail mill, vertical roller mill, hammer mill, roller press or high compression roller mill, vibration mill, or jet mill, among others. The particle size of the granules of milled xanthan gum can be adjusted by conventional dry sieving with appropriately sized sieves.

The particle size of the granular xanthan gum is determined by particle analysis using laser diffraction. Laser diffraction analysis depends upon analysis of the “halo” of diffracted light produced when a laser beam passes through a dispersion of particles in air or in a liquid and is based on the Fraunhofer diffraction theory, stating that the intensity of light scattered by a particle is directly proportional to the particle size. The angle of the laser beam and particle size have an inversely proportional relationship, where the laser beam angle increases as particle size decreases and vice versa. A useful particle size analyzer is the LS Particle Size Analyzer, LS 13 320, available from Beckman Coulter, Inc., 250 South Kraemer Boulevard, Brea, Calif. The mean particle size obtained by the use of this apparatus is volume based.

The mean panicle size of the granular xanthan gum, as measured by laser diffraction, will be greater than 40 micrometers. Typically, the mean panicle size is greater than about 45 micrometers, more typically greater than about 50 micrometers, and even more typically greater than about 60 micrometers. Preferably, the mean particle size is greater than 70 micrometers or about 80 micrometers, more preferably greater than about 90 micrometers, and even more preferably greater than about 100 micrometers. Even more preferred granular xanthan gums have a mean particle size of greater than about 110 micrometers, and even more preferably greater than about 115 micrometers. The mean particle size will typically range from about 100 micrometers to about 200 micrometers, more typically from about 110 micrometers to about 150 micrometers and even more typically from about 115 micrometers to about 125 micrometers.

The granular xanthan gum will typically have a narrow particle size distribution. Typically, the ratio of the mean particle size to median particle size will be less than about 1.5:1, more typically less than about 1.2:1, an even more typically less than about 1.1:1. Preferably, the ratio of the mean particle size to median particle size will be less than about 1.05:1. The granular xanthan gum will typically contain less than about 20%, and more typically less than about 10%, by volume of particles outside the range of from about 100 micrometers to about 200 micrometers, more typically from about 110 micrometers to about 150 micrometers and even more typically from about 115 micrometers to about 125 micrometers, and more typically less than about 5% by volume of particles outside these ranges.

The amounts of non-waxy wheat starch and granular xanthan gum in the compositions of this invention can vary widely, but non-waxy wheat starch will constitute more than 50% by weight of the blend, preferably from about 90% to about 99, more preferably from about 92% to about 96%, and even more preferably from about 93% to about 95%, by weight. Thus, the weight ratio of non-waxy wheat starch to xanthan gum will be greater than 1:1, preferably from about 9:1 to about 99:1, more preferably from about 11.5:1 to 24:1 and even more preferably from about 13:1 to about 19:1.

The compositions of this invention may also contain a dextrin in a minor amount by weight in addition to the major amount of the non-waxy starch and minor amount of granular xanthan gum. As used herein, the term “dextrin” means the products made by heating dry starch with or without acid. During the reaction, greater or lesser amounts of hydrolysis, transglycosidation, and repolymerization occur. According to which reaction predominates, the product is a white dextrin, a yellow dextrin, or a British gum. Preferred dextrins are white dextrins, especially those exhibiting low solubility, solution stability and dispersed viscosity, The weight ratio of non-waxy wheat starch to dextrin will typically range from about 1.5:1 to about 6:1, and more typically from about 2:1 to about 4:1, and even more typically from about 2,5:1 to about 3.5:1.

The baked foodstuffs of this invention can be any of a variety of baked goods, including without limitation, angel food cakes, yellow cake, sponge cake, chiffon cake, cookies, muffins, pancake and waffle mix, gluten free bread, gluten free rolls, gluten free cakes, gluten free muffins, gluten free cookies, and gluten free pancake and waffle mix. Preferred baked foodstuffs include aerated baked goods such as angel food cakes. The baked foodstuff will typically also contain a reduced amount of egg whites, typically from about 20% to about 60% less egg whites, more typically from about 30% to about 50%, less egg whites, and even more typically from about 35% to about 45% less egg whites, by weight. Water is also added to the baked good to compensate for the water contained in the omitted egg whites, in addition to the composition of this invention. It has been found that replacing only a portion of the water present in the omitted egg leads to increased cake height and reduced gumminess compared to replacing all of the water present in the omitted egg whites. Thus, it is advantageous to reduce the amount of water added to compensate for the omitted egg whites by from about 5% to about 35%, more typically from about 10% to about 30%, and even more typically from about 15% to about 25%, based on the weight of the water present in the omitted egg whites.

The baked foodstuff will also typically be comprised of wheat flour, and may also contain other ingredients typically used in baked goods such as sweeteners, food acids (e.g. cream of tartar), leavening agents, flavorings such as vanilla, and water. The amount of wheat flour in relation to the amounts of egg whites and the composition of this invention in the baked foodstuffs pf the invention will vary depending upon the specific nature of the baked foodstuff, but the ratios of wheat flour to egg whites to starch/gum composition will generally range from about 2-60:0.5-2:1, more typically from about 3-50:0.75-1.50:1, and even more typically from about 4-45:0.85-1.3:1, by weight.

The baked foodstuff may also contain other starch-based ingredients. One such ingredient is a dextrin, e.g. a tapioca dextrin, which will aid in forming a stable emulsion in a batter. The dextrin is typically added in an amount of from about 0.5% to 5% by weight, more typically from about 1% to about 2% by weight, of the baked foodstuff formulation. The dextrin may be present in the formulation as a result of pre-blending with the non-waxy wheat starch and granular xanthan gum.

The following examples will serve to illustrate the invention and should not be construed to limit the invention, unless otherwise provided in the appended claims.

### EXAMPLES

### Procedure for Making Angel Food Cake:

Angel food cake was prepared using a 20 quart Hobart 3-speed mixer. Reconstituted egg whites were made by mixing egg white powder (12%, plus assuming egg white powder has 10% moisture) and distilled water (88%) with a whisk until particulates of egg white powder is no longer visible and allowing to hydrate for at least 1 hour with periodic mixing. Reconstituted egg whites were then added to mixing bowl with vanilla extract and formula water. Temperature of this mixture was measured to be between 62 and 72° F. Using a whisk Hobart mixer attachment, the mix was mixed for 2 minutes at Speed 2. Part A (sugar plus cream of tartar) was then added and the mixture was continued to be foamed for 11 minutes (foam checked after 7 minutes for consistency). The temperature of the foam was measured to be between 64-74° F. A specific gravity of the foam was also taken and measured to be between 0.12-0.18. Part B (remaining dry ingredients) were then added to the foam in three parts. The mixer was turned on for a very short time after each part was added at speed 1 to hydrate the ingredients (approximately 5-7 seconds). The temperature and specific gravity was measured again and recorded. The angel food cake complete batter was then added to tube angel food cake pans (with detachable bottom) to 800 grams cake weight, and the batter was smoothed with a plastic bowl scraper to make the surface of the batter even and flat. The cakes were then baked in a MIWE electric conduction oven (available from MIWE Michael Wenz GmbH) for 43 minutes at 350° F. The MIWE oven has a heated top and bottom slab (both were on medium setting) and the vent system was assured be closed during baking. After baking, the cakes were taken out of the oven and then flipped over for cooling for approximately 1 hour, The cakes were then taken out of their pans and continued to be cooled to completion for another 30 minutes. The cakes were then packaged into 2-gallon re-sealable plastic bags and then placed into a deep freezer immediately. Prior to running any further analysis, the cakes were thawed.

### Cake Height Measurement:

Angel food cakes were thawed for approximately 24 hours prior to taking measurement. Cake height of the angel food cake was done using digital calipers by measuring the cake at four points (each 90° apart) at the outside of the cake ring, the inside of the cake ring, and the middle point of the cake ring. The diameter of the ring was also taken at four points. An average was taken from the four points measured and recorded as the dimension of the cake.

### Instrumental Texture Analysis of Angel Food Cake:

Angel food cakes were thawed for approximately 6 hours prior to taking measurement. Instrumental texture analysis of the angel food cake was done by using a TPA procedure using a TA-XT Plus (StableMicrosystems, Scarsdale, N.Y.) Texture Analyzer.

The following Texture Analyzer setting was used:
Pre-test Speed: 1 mm/s,
Test Speed: 5 mm/s),
Post-test speed: 5 mm/s
Compress to % Strain
Percent Strain: 50%
Trigger force: 5 g
Delay time between compressions: 5 seconds.
1 inch cylinder acrylic probe used

Texture properties that were recorded include hardness, springiness, resilience, cohesiveness, and gumminess and were calculated using the Stable Microsystems software. Hardness value was the peak force experienced during the first compression of the product (Units in grams). The Cohesiveness value was measured by the area under the curve of the second compression divided by the area under the curve of the first compression (no units). Resilience value was calculated by measuring by dividing the area under the curve of the withdrawal of the first compression divided by the area under the curve of the downstroke of the first compression (not units). Springiness was calculated by the detected height of the product on the second compression divided by the detected height of the product of the first compression (no units). Gumminess value was calculated by multiplying hardness by cohesiveness value (units in grams).

The starches used in the examples are described in Table 1, below.

TABLE 1

| Starch | | |
|---|---|---|
| Number | Starch Name and Manufacturer | Description |
| 1 | Regular Wheat Starch, available from | Native Regular Wheat |
| | MGP Ingredients, 100 Commercial | Starch |
| | Street, Atchison, Kansas | |
| 2 | Waxy Wheat Starch, available from | Native Waxy Wheat |
| | MPG Ingredients | Starch |

### Example 1 and Comparative Examples A-C

The amounts of the ingredients used in making the angel food cakes and properties of the resulting cakes are shown in Table 2 below.

TABLE 2

| | Example | | | | | |
|---|---|---|---|---|---|---|
| | Positive | Negative | | | | |
| | Control | Control | A | 1 | B | C |
| Starch Number | — | — | 1 | 1 | 2 | 2 |
| Starch Source | — | — | Regular | Regular | Waxy | Waxy |
| | | | Wheat | Wheat | Wheat | Wheat |
| | Wt. % | Wt. % | Wt. % | Wt. % | Wt. % | Wt. % |
| Part A | | | | | | |
| Sugar (Part A) | 20.10 | 20.52 | 20.55 | 20.55 | 20.55 | 20.55 |
| Cream of Tartar | 0.50 | 0.51 | 0.51 | 0.51 | 0.51 | 0.51 |
| Part B | | | | | | |
| Sugar (Part B) | 20.10 | 20.52 | 20.55 | 20.55 | 20.55 | 20.55 |
| Cake Flour | 15.93 | 16.26 | 16.29 | 16.29 | 16.29 | 16.29 |
| Salt | 0.18 | 0.18 | 0.18 | 0.18 | 0.18 | 0.18 |
| Starch¹ | 0 | 0 | 3.42 | 3.42 | 3.42 | 3.42 |
| Taploca Dextrin² | 0 | 0 | 1.14 | 1.14 | 1.14 | 1.14 |
| Xanthan Gum-Fine | 0 | 0 | 0.2 | 0 | 0.2 | 0 |
| Grind³ | | | | | | |
| Xanthan Gum- | 0 | 0 | 0 | 0.2 | 0 | 0.2 |
| Coarse Grind³ | | | | | | |
| Part C | | | | | | |
| Reconstituted Egg | 42.70 | 26.16 | 26.21 | 26.21 | 26.21 | 26.21 |
| Whites | | | | | | |
| Vanilla Extract | 0.50 | 0.51 | 0.51 | 0.51 | 0.51 | 0.51 |
| Water | 0.00 | 15.34 | 10.43 | 10.43 | 10.43 | 10.43 |
| TOTAL | 100 | 100 | 100 | 100 | 100 | 100 |
| Cake Height (mm) | 73.06 | 46.50 | 54.93 | 62.09 | 54.53 | 54.25 |
| Cake Hardness | 740 | 1397 | 1308 | 932 | 892 | 1303 |
| Cake Gumminess | 546 | 885 | 784 | 667 | 642 | 822 |

¹See table above for details on starches used.
²Tapioca Dextrin used was CRYSTAL TEX ® 644 dextrin, available from Ingredion.
³Xanthan Gum used was KELTROL ® brand xanthan, CP KELCO, 3100 Cumberland Boulevard, Atlanta, Georgia; Fine grind had a mean particle size of 39.58 micrometers, and Coarse grind had a mean particle size of 122.2 micrometers.

### Conclusions:

The results in Table 2 show that coarse grind xanthan gum performed significantly better as an egg white extender in angel food cake with the tested non-waxy wheat starch than fine grind xanthan gum in terms of cake height, hardness, and gumminess, but not with waxy wheat starch. The cakes with fine grind xanthan gum were significantly harder, had a lower cake height, and were gummier.

### Example 2

A traditional yellow layer cake can be made using an egg white extender of the invention.

| | |
|---|---|
| Ingredients | Wt. % |

Part A

| | |
|---|---|
| Sugar | 26.78 |
| Cake Shortening-US DDA Emulsified | 12.28 |

Part B

| | |
|---|---|
| Cake Flour | 23.59 |
| Baking Powder | 0.90 |
| Salt | 0.22 |
| Nonfat Dry Milk | 2.52 |
| Dry Egg Whites | 0.71 |
| Wheat Starch #1 | 0.51 |
| Xanthan Gum¹ | 0.028 |
| Tapioca Dextrin - CRYSTAL TEX ® 644 | 0.17 |

Part C

| | |
|---|---|
| Egg yolk-liquid | 5.25 |

Part D

| | |
|---|---|
| Water | 26.29 |
| Vanilla Extract | 0.75 |
| TOTAL | 100.00 |

¹Xanthan Gum is KELTROL brand xanthan, CP KELCO, with a mean particle size of 122.2 micrometers.

A control yellow cake formula is below:

| | |
|---|---|
| Ingredients | Wt. % |

Part A

| | |
|---|---|
| Sugar | 26.78 |
| Cake Shortening-US DDA Emulsified | 12.28 |

Part B

| | |
|---|---|
| Cake Flour | 23.59 |
| Baking Powder | 0.90 |
| Salt | 0.22 |
| Nonfat Dry Milk | 2.52 |
| Dry Egg Whites | 1.41 |

Part C

| | |
|---|---|
| Egg yolk-liquid | 5.25 |

Part D

| | |
|---|---|
| Water | 26.29 |
| Vanilla Extract | 0.75 |
| TOTAL | 100 |

The cakes can be manufactured by following the steps below:

### Preparation:

1. Sift together all of the dry ingredients (B). Set aside.
2. Cream the shortening and sugar (A) together in a Hobart N50 mixer at Speed 1 for 1.5 minutes and Speed 2 for 1.5 minutes
3. Add the eggs gradually while mixing at Speed 1. After all eggs are incorporated, mix at Speed 1 for 30 seconds, then Speed 2 for 1.5 minutes.
4. Blend the water and vanilla (D) together.
5. Alternately add A and liquid in 3 parts at Speed 1. Scrape bowl, Mix for additional 1.5 minutes at Speed 2
6. Stop mixing when batter is uniform. Do not overmix.
7. Pour batter into a 8-inch cake pan and bake for 27 minutes@350° F., 500 grams per pan in a conduction oven

### Example 3

Muffins can be made using the following formula

| Ingredients | Wt. % |
|---|---|
| All Purpose Flour | 28.587 |
| Sugar | 17.79 |
| Baking Powder | 1.49 |
| Salt | 0.23 |
| Milk Powder- | 2.23 |
| nonfat, hi-heat | |
| Shortening | 11.86 |
| Whole eggs- | 4.45 |
| Liquids | |
| Wheat Starch No. 1 | 0.801 |
| Dextrin¹ | 0.267 |
| Xanthan Gum² | 0.045 |
| Water | 21.8 |
| Blueberries | 9.91 |
| Vanilla Extract | 0.54 |
| Total | 100 |

¹Tapioca Dextrin used was Crystal Tex 644 dextrin, available from Ingredion.
²Xanthan Gum used was KELTROL brand xanthan, CP KELCO, with a mean particle size of 122.2 micrometers.

### Preparation: (Standard Batch Size: 1000 g)

1, Blend dry ingredients.
2. Add dry bend to Hobart and add in liquids. Mix until uniform.
3. Place batter in lined muffin pan.
4. Bake at 375° F. for 14-18 minutes.

What is claimed is:

1. A composition useful as a replacement for egg whites in a baked foodstuff comprising a major amount of a non-waxy wheat starch and a minor amount of granular xanthan gum, said granular xanthan gum having a mean particle size greater than 40 micrometers.

2. The composition of claim 1, wherein the mean particle size is greater than about 45 micrometers.

3. The composition of claim 1, wherein the mean particle size is greater than about 100 micrometers.

4. The composition of claim 1, wherein the mean particle size is from about 100 micrometers to about 200 micrometers.

5. The composition of claim 1, wherein the ratio of mean particle size to median particle size is less than about 1.5:1.

6. The composition of claim 1, wherein the weight ratio of non-waxy wheat starch to granular xanthan gum is from about 9:1 to about 99:1.

7. The composition of claim 1, further comprising a minor amount of a dextrin.

8. A method of replacing egg whites in a baked foodstuff comprising adding a major amount of a non-waxy wheat starch and a minor amount of granular xanthan gum, said granular xanthan gum having a mean particle size greater than 40 micrometers, to replace a portion of the egg whites in a baked foodstuff.

9. The method of claim 8, wherein the mean particle size is greater than about 45 micrometers.

10. The method of claim 8, wherein the mean particle size is greater than about 100 micrometers.

11. The composition of claim 8, wherein the mean particle size is from about 100 micrometers to about 200 micrometers.

12. The method of claim 8, wherein the ratio of mean particle size to median particle size is less than about 1.5:1.

13. The method of claim 8, wherein the weight ratio of non-waxy wheat starch to granular xanthan gum is from about 9:1 to about 99:1.

14. The method of claim 8, wherein the amount of water added is a portion of the amount of water present in the omitted egg whites.

15. The method of claim 8, wherein the amount of water added from about 10% to about 30% less than the amount of water present in the omitted egg whites.

16. The method of claim 8, further comprising adding a dextrin.

17. A baked foodstuff comprised of egg whites, wherein at least a portion of the egg whites are replaced with a major amount of a non-waxy wheat starch and a minor amount of granular xanthan gum, said granular xanthan gum having a mean particle size greater than 40 micrometers.

18. The baked foodstuff of claim 17, further comprising a minor amount of a dextrin.

19. A baked foodstuff composition a comprising a minor amount by weight of egg whites, a minor amount by weight of non-waxy wheat starch, and a minor amount by weight of granular xanthan gum, said granular xanthan gum having a mean particle size greater than 40 micrometers

20. A composition useful as a replacement for egg whites in a baked foodstuff comprising a non-waxy wheat starch, a granular xanthan gum, said granular xanthan gum having a mean particle size greater than about 100 micrometers and a ratio of mean particle size to median particle size of less than about 1.5:1, and a white dextrin, wherein the weight ratio of non-waxy wheat starch to granular xanthan gum is from about 0:1 to about 99:1 and the weight ratio of the non-waxy wheat starch to white dextrin is from about 1.5:1 to about 6:1.
